(19) United States
(12) Patent Application Publication
(10) Pub. No.: US 2011/0288894 A1
(43) Pub. Date: Nov. 24, 2011

(54) Method of an a Network Node in a Telecommunications System for Registering a Custody Relation for an Object of Custody

(76) Inventors: Mathias Hubertus Maria Hutschemaekers, Hm Poederoijen (NL); Elizabeth Van Sluis, He Breda (NL)

(21) Appl. No.: 13/144,387

(22) PCT Filed: Jan. 14, 2009
(86) PCT No.: PCT/EP09/00167

§ 371 Date: Aug. 3, 2011

(51) Int. Cl. G06Q 10/00; G06Q 40/00; G06Q 50/00; G06F 17/30

(52) U.S. Cl. 705/5; 707/792; 707/705; 705/40; 707/E17.044

(57) ABSTRACT

For providing, to a custody service user (30), a temporary custody service for an object of custody, a network node (32)) in a telecommunications system (1) stores data (21) uniquely identifying the object of custody and contact information of the parties (30, 31) in a custody relation in an electronic database (20). The network node (32) enables communication between the parties (30, 31) without disclosing the contact information to each other, by using the data stored (21). The custody relation can be terminated by a check-out procedure, initiated by any of the parties (30, 31) using telecommunication equipment (5, 6, 7, 9). There is provided a network node (32) arranged for registering a custody relation (43) between a custody service user (30) and a custody service provider (31) providing a custody service for an object of custody.

### TECHNICAL FIELD

The present invention relates generally to telecommunications and, more specifically, to the technical steps of and equipment for registration of a custody relation between a custody service user and a custody service provider, such as a kindergarten, a pet kennel or valet car parking facilities, for an object of custody, such as children, pets or non-living objects, for receiving a temporary custody service, using telecommunications facilities.

### BACKGROUND

In practice, numerous temporary “looking after” or custody services are provided, in which registration is required of an object of custody and of information about the custody service user. Examples of such services include, but are not limited to, kindergartens located at shopping centers, where children are left to be looked after by attendants for a couple of hours, while parents go shopping; pet kennels, which admit pets for a short-term stay when the owner has to go away for a few days; or valet parking facilities at airports, where the owner may have the car parked and secured during his absence and return on arrival to the car parking or the airport.

In all the aforementioned situations, the temporary custody service requires a registration, which comprises at least a unique identification of the object under custody, such as a child or a car, and information regarding the custody service user, i.e. the person or persons entitled to the object under custody, for example a parent or the car owner. This ensures that the correct object can be retrieved and returned to the correct person and that the party providing the custody service can be assured that the object under custody is returned to the correct person, i.e. the custody service user. The information regarding the custody service user includes contact information of the custody service user, such that same may be contacted if there is a need for during the service.

In case of kindergartens at shopping centers, for example, the registration procedure is done in manually written records, in paper or in electronic form, from which the information has to be then retrieved. This process is not only cumbersome and time-consuming, but also unreliable and sensitive to failures. If the kindergarten needs to contact the parent, for example when a child wants to be picked up, and contact information to the parent is missing, incomplete or illegible—which may often happen to information written by hand in a hurry—a public announcement throughout the shopping centre has to be made, specifying details of the child and/or the parent.

In an other situation, if a child unintentionally gets separated from the parents, for example in an adventure park, a shopping centre or on the beach, and is then found, it is also necessary to make a public announcement and specify details of the child and the location where the child can be picked up. Of course, a method of contacting parents involving a public announcement is privacy unfriendly and brings about the additional problem of identification of the person who comes to pick up the child, or in general the object of custody.

Moreover, depending on the situation, the parent/owner may also need to contact the party providing the custody service, i.e. the custody service provider, during the service. For example, a parent may want to find out how the child is doing or an owner may want the car back earlier than initially agreed. In the situations described above, such contact is possible either by a telephone call or in person. Both options engage the custody service provider and might be time-consuming and again involves the problem of proper identification of the custody service user by the custody service provider.

From an insurance point of view, a proper and reliable registration of the duration of an actual custody relation is required, as insurance companies may only be liable for damages occurred during the time that the custody relation is actually in place.

A further disadvantage of known methods of registration is that the contact information of the service user is known by the service provider and can be used for all kind of purposes, in some cases in a way not appreciated or approved by the service user.

### SUMMARY

An object of the present invention is to support the provision of a custody service which is free of the above-mentioned limitations and disadvantages for both the custody service user and the custody service provider.

Unless explicitly stated otherwise, throughout this description and in the claims:
the object of custody should be understood as a living object, like a child or a pet, or a non-living object, like a car, temporarily given into custody;
the custody service should be understood as a looking-after service such as a kindergarten or a pet kennel in case of living objects, or a storage such as a valet parking in case of non-living objects;
the custody service provider should be understood as a party providing the custody service;
the custody service user should be understood as the party using the custody service, such as a parent or car owner, by temporarily giving into custody of the custody service provider an object to which the custody service user is in some way entitled or related.

In a first aspect there is provided a method of registering a custody relation in an electronic database by a network node in a telecommunications system for an object of custody for receiving a temporary custody service. The network node executes the steps of:
storing data in the electronic database uniquely identifying the object of custody and contact information of parties in a custody relation, the parties being a custody service provider and a custody service user, and
enabling communication between the parties using the contact information stored in the database.

Both parties are linked by the identified object of custody in a custody relation, which is registered by the network node in the electronic database in connection with relevant contact information of both parties. Using an electronic database, accessible via a telecommunications system or network, provides a fast and reliable source of information for identifying the object of custody and the parties in the custody relation, and enables easy contact between parties.

The contact information of either party enabling communication between the parties does not need to be know to the other party, such that with the invention this contact information is safeguarded against malicious use.

Further, storage of the custody relation in the electronic database under the control of a network node may serve as a legal entitlement for holding an object of custody in a custody relation by a custody service provider, among others to be used for insurance companies.

For information purposes, the data stored in the electronic database in connection with a custody relation may be accessible by communication means to both parties. From a privacy point of view, however, the contact information of a party stored in the electronic database may not be available or accessible to the other party.

According to an example of the method, the network node further executes the steps of:
receiving a custody service request from a custody service user, the custody service request including data identifying the custody service provider, data identifying the object of custody and contact information of the custody service user,
storing the custody service request in the electronic database,
forwarding a check-in request to the custody service provider identified in the custody service request,
receiving a check-in reservation notification of the custody service request from the custody service provider, the check-in reservation notification comprises contact information of the custody service provider,
storing the check-in reservation notification in the electronic database,
correlating the stored check-in reservation notification with the stored custody service request, and
forwarding a custody service reservation notification to the custody service user.

The identification of the custody service provider used by the custody service user when placing the custody service request may be a public identity of a particular service provider, a public identity of a type of custody service or a public identity of a group of custody service providers, for example, such as a public telephone number, a public e-mail address, or the like.

The network node may comprise a list of public identities of service providers, linked by a more general or comprehensible identification, like a name or abbreviation of a particular service provider, a particular group of service providers and the like. This list can be a static list, or a very dynamic list in which custody service providers can also indicate whether they are available or not.

For example, parents arrive with their child in a shopping center and discover that there is a kindergarten facility. They decide to make use of its services and, using telecommunications equipment, send a custody service request including the required data as disclosed above to an address (such as a telephone number or an e-mail address) that is shown at the kindergarten premises or received from the staff of the kindergarten, for example. The address provided can be a general custody service address related to a network node that executes the registration of custody services or an address that directly identifies a particular custody service provider, for example. In the latter case it will be appreciated that an identification of the custody service provider is already implicitly provided by sending a custody request to the address provided.

As explained above, in accordance with the invention, the network node executing the registration of a custody relation, forwards a check-in request to telecommunications equipment of the particular kindergarten. The kindergarten, as custody service provider, may check that the provided details are sufficient to identify the child that is about to be handed over and returns a check-in reservation notification to the respective network node, which may indicate that the information is correct or sufficient and indicates that the kindergarten is ready or willing to provide the requested custody service.

The network node correlates the custody service request and the check-in reservation notification. Because, in this example, the check-in reservation notification indicates that the requested custody service can be provided, the network node delivers a positive or confirming custody service reservation notification to the parents, using the contact information provided in the custody service request. Through the network node, using the contact information stored, the kindergarten and the parents, i.e. the custody service provider and the custody service user, may contact each other by communication means, dependent on the type or types of contact information stored, i.e. telephone number, e-mail address, and so on.

It is noted that the check-in reservation notification provided by the custody service provider may also indicate that the check-in request is not accepted. In such a case the correlation step in the network node will result therein that the custody service user receives a negative or non-confirming custody service reservation notification.

In the case of a custody service request forwarded to a particular group of service providers, such as a plurality of kindergartens at a shopping centre, in the event of a negative correlation, the correlation step may forward a check-in request to another service provider of the group, etc. If the check-in request cannot be accepted at all, the custody service user will receive a negative custody service reservation notification and the information stored in relation to the custody service request may be deleted by the network node.

The actual custody relation is established with the physical handover of the object of custody from the custody service user to the custody service provider. In an example, the network node is arranged for executing the steps of:
receiving a custody relation acceptance notification from the custody service provider, the custody relation acceptance notification including a reference to a stored custody service request,
forwarding a custody relation acceptance confirmation to the custody service user,
receiving a custody relation acceptance acknowledge from the custody service user, and
validating the custody relation in said electronic database in response to the receipt of the custody relation acceptance acknowledge.

In the above example, the handover of the object of custody is signaled to the network node on the initiative of the custody service provider. It will be appreciated that the actual custody relation, in a further example, may also be initiated from the custody service user. To this end, the network node is arranged to execute the steps of:
receiving a custody relation acceptance notification from the custody service user, the custody relation acceptance notification including a reference to a stored custody service request,
forwarding a custody relation acceptance confirmation to the custody service provider,
receiving a custody relation acceptance acknowledgement from the custody service provider, and
validating the custody relation registered in said electronic database in response to the receipt of the custody relation acceptance acknowledgement.

Validation or establishing of the custody relation may comprise storage of the custody relation acceptance notification and the custody relation acceptance acknowledge, which may serve as the legal entitlement of the custody relation, among others for insurance purposes. Validation may also include the step of informing both parties of the actual establishment of the custody relation.

In the above examples, handover of the object of custody is established at a point in time after the reservation of a service request has been notified to the custody service user. However, in the case of a kindergarten, for example, where a child can be directly handed over at the time of placing the custody service request, the steps of providing a check-in reservation notification and a custody relation acceptance notification by the custody service provider can be combined into a single check-in acceptance notification. In this example, the network node will directly store and correlate the received check-in acceptance notification and provide a custody service acceptance confirmation to the custody service user. The custody relation is established by validating the check-in acceptance notification and a custody relation acceptance acknowledge received form the custody service user.

For referring to a stored custody service request, in another example, the messages, i.e. request, confirmation, notification and acknowledge, exchanged may comprise a transaction code, a reservation code, a custody relation number, or any other piece of information or code by which the messages exchanged may refer to a particular custody service request, and that can be used by the network node, the custody service provider and the custody service user as a reference to a stored custody service request. It will be appreciated that where in the above is referred to custody service user and custody service provider, messages with the network node are exchanged between communication equipment used by the custody service user and custody service provider.

A similar sequence of steps may occur while registering a parking space at a valet parking, for example.

In the above examples, if a custody service request is placed to a public identity of a group of custody service providers, for example a number of kindergartens located at or in the neighborhood of a shopping centre, the network node may send a check-in request to all the kindergartens available or all the kindergartens at or near the shopping centre, that support service requests via the network node, for example on a subscription bases. If a check-in request is accepted by a kindergarten, the correlation step is arranged such that the other kindergartens who have received the check-in request will receive a cancellation notification.

Instead of or in addition to forwarding a check-in request to custody service providers, in another example, custody service providers and custody service users may browse through the electronic database to discover whether check-in requests are placed and/or accepted or reserved. To this end, in a further example, the network node provides access to custody service request data and check-in reservation notification or check-in acceptance notification data stored in the electronic database for browsing through said data by a custody service user and a custody service provider.

In the kindergarten example described above, the custody service request from the parents, i.e. the custody service user, may result in broadcasting and/or sending a notification of a stored check-in request to all kindergartens in the shopping centre recognized by the electronic database, i.e. the custody service provider, by the network node.

Alternatively, the check-in request may be selectively sent to one or all those custody service providers who declared the possibility to provide the custody service within a time period matching the parents' needs, for example. To this end, the network node has to assess the custody service request for a match with availability data or the like. It will be appreciated that the network node may than skip the steps of forwarding a check-in request and receiving a check-in reservation notification or a check-in acceptance notification and storage thereof, and may directly forward a custody service reservation notification to the custody service user. The availability data of the service provider already stored in the electronic database may be updated by the network node according to the custody service reservation notification. The contact information of the custody service provider may be implicit in this case.

To facilitate such features, in example, the network node executes at least one of the steps of:
semi-permanently storing, in the electronic database, contact information of a custody service provider in relation to public identification data of the custody service provider,
semi-permanently storing, in the electronic database, data relating to services of a custody service provider,
semi-permanently storing, in the electronic database, data uniquely identifying an object of custody in relation to identification data of the object of custody, and
semi-permanently storing, in the electronic database, contact information of a custody service user in relation to identification data of the custody service user.

Availability of a requested custody service may directly be established by the network node, in a yet further example, in a step of correlating semi-permanently stored data with the stored custody service request.

The data uniquely identifying the object of custody and contact information of the custody service user can be provided in the custody service request explicitly or implicitly—by appropriate reference to information already stored in the electronic database, in the case when the object of custody and/or the custody service user have been previously registered and the custody service user had no objection to the data being held. The custody service provider and the custody service user may also pre-register itself in the electronic database.

In the example of the method wherein the electronic database semi-permanently stores contact information of the parties, a party can be easily identified/specified by, for example, a reference or code number corresponding to the stored contact information relating to this party. In the same way such information may be retrieved from the electronic database. For example, if the parents want a particular kindergarten that is pre-registered in the electronic database to look after their child, it is sufficient for them to specify in the custody service request a suitable comprehensible reference or code number identifying this kindergarten, instead of giving this kindergarten's address and/or other contact information. Moreover, a party may also access the electronic database in order to retrieve contact information of the other party in case that contact is needed.

In the example of the method wherein the electronic database semi-permanently stores additional information related to the object of custody, this information may be of any kind possible to store in an electronic database, including text, numbers, pictures, audio files, video files, multimedia files etc. For example, this information may include dietary requirements and information about allergies in case of children, or pictures of known damages of a car, which is being left in a parking facility.

In another example of the method, the network node communicates an entry point in the electronic database corresponding to the (potential) custody relation between the parties. This entry point may be provided in the check-in request and the custody service acceptance confirmation, for example. This entry point enables a party to obtain additional status information about the object of custody. For example, it may concern a web address that leads to a web camera showing the object.

According to an example of the method, additional information related to the custody relation provided by the custody service provider is included in the custody relation acceptance notification. This information may, for example, relate to costs of the custody service. But it may also be a password required to access the aforementioned entry point, for example a web camera, and/or to retrieve the object of custody. As this additional information is selectively sent to the other party only, its confidentiality is assured.

The custody service reservation notification or the custody relation acceptance confirmation or the custody service acceptance confirmation received by the custody service user may be stored on the telecommunications equipment of a custody service user as an entitlement of this party to a respective service or object of custody. This makes the identification procedure during check-out very fast and simple. A person may be identified, for example, by showing the reservation or confirmation received in a form of SMS or the like on the screen of his mobile phone, or the custody acceptance notification may comprise other information like a code number or code word, for identifying the custody service user or the custody service provider in the established custody relation, as elucidated above.

The invention provides also a method for termination of a custody relation between the parties, wherein the network node further executes the steps of:
receiving a check-out request from a first one of the parties,
sending a check-out notification to a second one of the parties after the check-out request is received,
receiving a check-out acceptance notification from the second party, and
sending a custody end notification to the first party after receipt of the check-out acceptance notification, and
deleting a custody relation between parties from the electronic database after sending a custody end notification to the first party.

Any of the parties may terminate a custody relation and, by concordant statements of both parties, the custody relation linking the parties is terminated. By sending the end notification after receipt of the check-out acceptance notification, termination of the custody relation is successfully completed and confirmed. The custody end notification may be regarded as a proof that there is no more obligation between the parties relating to the terminated custody relation. Note that any of these requests and notifications can be done remotely, for example by a mobile phone or a data web terminal, as disclosed above.

All information relating to the custody relation may be deleted from the electronic database.

However, in a further example of the invention, a history record comprising data relating to the terminated custody relation is stored or maintained in the electronic database, for example comprising data for financial, tax and/or statistical purposes.

This alternative enables to cover multiple custody relations with one payment, for example. This is convenient if the custody service user uses the custody service provided by a given provider relatively regularly, while the cost of each individual custody relation is relatively low. One can easily imagine a person who regularly travels by plane, each time leaving his car in the same parking facility or parents who use a kindergarten service one evening each week. Each time the cost of the service is not remarkable, so it makes sense to pay a larger amount once a month.

Also, with the user's consent, information such as contact information or identifications of objects may remain in the data base, for future use.

In a still further example of the invention, the network node further executes the step of charging costs relating to the custody relation to at least one of the parties. Preferably, this step is executed before sending the end notification termination and deletion or after the termination of the custody relation.

If parents would like to deliver more than one of their children at a kindergarten facility, for example, for each child a separate custody relation may be entered. However, it will be appreciated that in such a case the object of custody, as disclosed above, may comprise several children, each of which being uniquely identified in one custody relation. Similar examples can be construed, like several pets in a kennel, for example.

The method according to the invention is also very suitable for the purpose of retrieving a child that is unintentionally separated from the parents, for example in an adventure park, a shopping centre or on the beach. In such case, the custody service provider is a rescue service or the police, for example. Placing the request will directly lead to the receipt of a check-in acceptance notification, i.e. the rescue service and/or the police will start a search or rescue operation in relation to the object of custody.

With the method of the invention, when the child is found, the parents, i.e. the custody service user, can be retrieved via the contact information provided and registered, without having to make a public announcement concerning details of the child and the location where the child can be picked up by the custody service provider.

Generally, the steps included in the method provide a confidential and reliable registration of a custody relation and contact between parties using electronic means and communication equipment, such as a mobile or wired telephone, a wireless or wired data terminal, and the like, either manually or automatically under the control of suitable support software, in particular from the side of the custody service provider. Identification information of the parties may include telecommunication system subscriber numbers, mobile identification numbers or specific information such as agreed passwords, code numbers, and the like.

In the method according to the invention, the telecommunication system may be any known telecommunication system, such as but not limited to wired or wireless analogous or digital telecommunications systems, arranged for speech and/or data communication, and the like. The electronic database can be accessed by corresponding communication means by exchanging data, requests and notifications in the form of e-mail messages, Short Message Service, SMS, Multimedia Messaging Service, MMS, and spoken messages, for example. Using such communication means makes the act of accessing the electronic database and in particular the act of registration of the object of custody for the custody service easy, fast and reliable.

The present invention provides in a second aspect also a network node for use in a telecommunications system for registering a custody relation in an electronic database for an object of custody for receiving a temporary custody service, wherein the network node comprises custody service equipment arranged for executing the method as disclosed above.

The network node in this context may be understood as one having technical equipment to communicate with an electronic database. This technical equipment may involve hardware and/or software means.

The network node may be arranged as a Private Branch Exchange, PBX, a Service Control Point, SCP, a Mobile Switching Centre, MSC, a Gateway Mobile Switching Center, GMSC, a General Packet Radio Services Support Node, GSN, a Media Gateway, MGW, a Session Control Function server, SCF, or the like.

The electronic database may be comprised in the network node and/or the electronic database is a central database. A central database is easily separable from both parties and can be provided and/or operated by an independent company or institution. In such case both the custody service provider and/or the custody service user may be regarded by the database operator as clients, who can pay for a convenient service.

Alternatively the network node in this context may be understood as a device used by a party to send and/or receive messages and establishing communication according to the invention as disclosed above. Such device may be provided with technical equipment for sending and/or receiving requests and notifications. The technical equipment may include hardware and/or software means.

Various aspects of the invention will now be illustrated in more detail with reference to the following description and accompanying drawings. The examples of the invention disclosed are indicative for implementing the invention and are not intended nor to be construed as limiting the invention, the scope of which is defined by the appending claims.

### BRIEF DESCRIPTION OF THE DRAWINGS

FIG. 1 shows, in a schematic and illustrative manner, an example of a telecommunications system 1 arranged for operating the present invention.

FIGS. 2, 3, 4 and 5 show, in schematic and illustrative signal flow diagrams, examples of the method according to the present invention.

FIG. 6 shows, in a schematic and illustrative representation, semi-permanent storage of data of parties.

### DETAILED DESCRIPTION

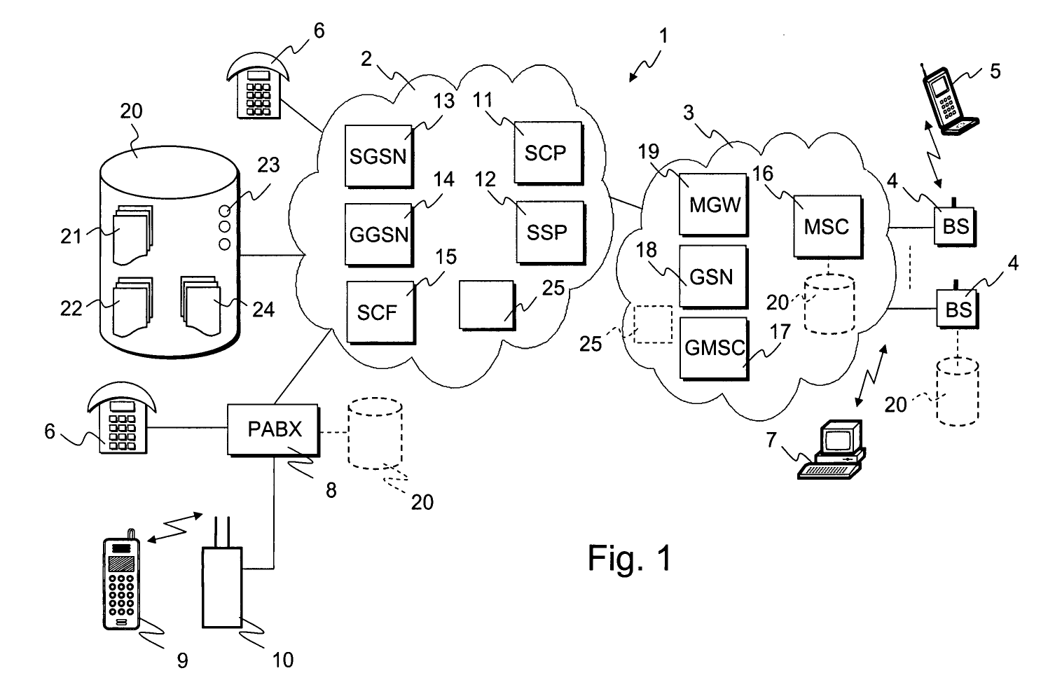

FIG. 1 shows, in a very schematic embodiment, an example of a telecommunications system 1 arranged for operating the present invention. For illustration purposes, the telecommunications system 1 comprises both a fixed network part 2 and a wireless network part 3.

The fixed or wired network part 2 may comprise a Public Switched Telephone Network (PSTN) and/or an Integrated Services Digital Network (ISDN), preferably an Intelligent Network (IN) configuration, comprising one or a plurality of network nodes or servers. Dependent on the transmission technology and schemes implemented, such network nodes may be arranged as a Service Control Point, SCP, 11, a Service Switching Point, SSP, 12, a Serving GPRS Support Node, SGSN, 13, or a Gateway GPRS Support Node, GGSN, 14, a Session Control Function server, SCF, 15, of an IP Multimedia Subsystem, IMS, for example.

The wireless network part 3 may comprise, for example, a Mobile Switching Centre, MSC, 16, controlling several radio access units or radio Base Stations, BS, 4, such as operating under the Global System for Mobile communications, GSM, or other suitable wireless communication protocol. The mobile network part 3 may also comprise a Gateway Mobile Switching Center, GMSC, 17, a General Packet Radio Services Support Node, GSN, 18, a Media Gateway, MGW, 19, or the like, coupled to the fixed network part 2, such as well known to those skilled in the art.

Users or subscribers, which in the context of the present invention may be considered as custody service users or custody service providers, communicate with a mobile telecommunications terminal 5 via the mobile network part 3 or with a wired telecommunications terminal 6 via the fixed network part 2 of the telecommunications system 1. Although the communications terminals 5, 6 are depicted as telephones, it will be appreciated that user terminals may constitute data terminals, such as laptops, personal computers, Personal Digital Assistant equipment, PDA, and many others, schematically indicated by reference numeral 7.

Users or subscribers may also communicate via a Private Automatic Branch eXchange (PABX) 8, either by a wired communication terminal 6 or a local wireless communication terminal 9 via a local Radio Access Unit, RAU, 10.

For the purpose of the present invention, the telecommunications system 1 includes at least one electronic database 20 which is, among others, arranged for operating as an electronic database for storing data for uniquely identifying the object of custody and contact information of parties in a custody relation. In the embodiment shown is the electronic database 20 central to the telecommunications system 1. However, the electronic database may also be central to a network part 2, 3 of the telecommunications system and/or may be provided as an electronic database comprised in or by at least one network node 11-19, a PABX 8, a BS 4 or an RAU 10, for example, as indicated by dotted lines.

In accordance with the invention, at least one network node 11-19, a PABX 8, a BS 4 or an RAU 10 of the telecommunications system 1 comprises custody service equipment, generally indicated by reference numeral 25, arranged for providing one or more of accessing an electronic database 20 for creating custody relations, for example in the form of custody service records 21 referring to a custody relation, for updating and amending custody relations, for retrieving data from a custody relation, such as from a custody service record 21 associated with a custody relation in the electronic database 20, for exchanging notifications between communication means 5, 6, 7, 9 of parties in a custody relation, for creating entry points 23 in the electronic database 20 and for the purpose of registering and charging costs in any or a plurality of payment scenarios for the use of a custody service during a custody relation and for keeping history records, for example.

The custody service equipment 25 may take the form of a software application for execution by a computer or processor or the like, which processor may already be available in a network node 11-19, or may be designed as a special piece of hardware equipment arranged for performing the functions required in relation to the present invention, or as a combination of both. The custody service equipment 25 may be accessible to the users of the telecommunications system 1 by selecting or dialing a (special) service subscription number, through a special (text) string in an SMS, via an e-mail address, or any other form of access available to the users or subscribers of the telecommunications system 1, as will be appreciated by the skilled person. Although shown separately, an electronic database 20 and the custody service equipment 25 may be integral.

Examples of the method of registering a custody relation in accordance with the present invention will now be elucidated in connection with a custody service provided by a kindergarten, such as a kindergarten in a shopping centre, acting as the custody service provider, wherein the object of custody is a child (or a plurality of children) and the custody service user is a parent of the child, for example. Communication is performed using the well known SMS. It will be appreciated that the invention is not limited to SMS, nor to its use in relation to a kindergarten, as noted above.

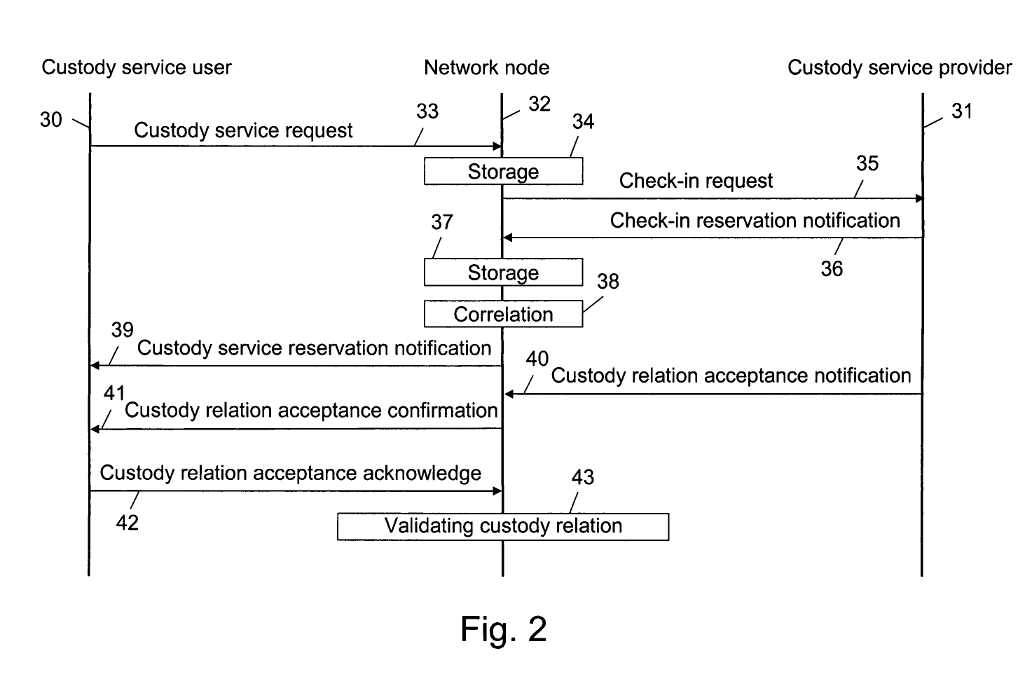

In the simplified signal flow diagram of FIG. 2, wherein time is running from top to bottom, during shopping, the parent, i.e. the custody service user 30, would like to leave its child, i.e. the object of custody, with the kindergarten, i.e. the custody service provider 31. The custody service 32 to be provided by the custody service provider 31 is a temporary, for example a couple of hours, look after service in relation to the object of custody during a certain period of time.

To this end, from his or hers mobile telecommunications terminal 5, the custody service user 30 places by SMS a custody service request 33 to the custody service equipment 25 in a network node 32, which is one the network nodes 11-19 shown in FIG. 1. Such a custody request 33 can be directed to a public telephone number or public e-mail address which is indicated at the premises of the kindergarten or at a shopping centre where the kindergarten is located or may be known to the parents beforehand, for example. On the other hand, a custody service request 33 can be placed to a general service number of a custody service hosted by the custody service equipment 25 of the network node 32 and separately specifying the requested service provider by its public identification, for example. In relation to the receipt of the custody service request 33 by the custody service equipment 25 in a network node 32, data is to be stored 34 in the electronic database 20, preferably in the form of a custody service record 21, for the purpose of registering a custody relation individual to the custody service user 30 and the custody service provider 31 of the requested custody service for an object of custody.

The data to be stored serves the purpose of uniquely identifying the object of custody and comprises contact information of the custody service user 30. In an example, identification data of the object of custody may be directly included in the custody service request 33, for example a text string describing particularities of the child such as boy or girl, name, age, length, color of the hair, type of cloths, etc. as well as contact information of the custody service user 30. In the case of a mobile telecommunications terminal 5, this contact information may include the telephone number of the terminal which may be automatically included in the SMS. Of course other contact information may be specified, such as a fixed telephone number of the custody service user 30, identity card number of the custody service user 30, name and address of the custody service user 30, and so on. Note that such an SMS custody service request 33 may be prepared once on the mobile telecommunications terminal 5 and stored therein for future use.

If the custody service provider 31 is already known and if availability for taking the service request is no issue to be negotiated, or is already negotiated in person with the staff of the kindergarten, for example, data identifying the custody service provider 31 can be automatically incorporated in the custody service record 21 to be stored in the electronic database 20 by the custody service equipment 25 of the network node 11-19. Otherwise, a check-in request 35 has to be sent to the identified custody service provider 31 by the custody service equipment 25 of the network node 32 after receipt of the custody service request 33.

In response to the receipt of the check-in request 34, the custody service provider 31 forwards a check-in reservation notification 36 to the custody service equipment 25 of the network node 32. This check-in reservation notification 36 comprises contact information of the custody service provider 31 and data relating to the request, i.e. whether the request can be accepted, whether the request is refused, for example in that the information relating to the object of custody is not sufficient or correct for identification purposes, requesting further or additional information, for example, or alternatives for taking the request by the custody service provider 31, for example at a different time period during the day then originally requested. The check-in reservation notification 36 is stored 37 in the respective custody service record 21 relating to the custody service requested, by the custody service equipment 25 of the network node 32. The check-in reservation notification 36 may be generated automatically by suitable equipment at the side of the custody service provider 31 or manually, for example based on a check of the completeness of the information provided.

The check-in reservation notification 36 received by the custody service equipment 25 of the network node 32 may comprise part of the information identifying the object of custody, for example, as registered in the custody service record 21 in the electronic database 20 or other information that directly relates to a respective custody service request 33. In such a case, the custody service equipment 25 of the network node 11-19 performs a step of comparing the registered custody service request 33 and the received check-in reservation notification 36, whether same relate to the same object of custody.

From the above, it will be clear that the custody service record 21 comprises data identifying the parties 30, 31 involved. In accordance with the invention, the custody service equipment 25 of the network node 32 is arranged to provide access to the parties 30, 31 involved based on their identifications or by providing, to the parties involved, information pertaining to the custody service record 21, such as a record number or record name or the like for accessing the custody service record 21. The access to the data base may be restricted so that the parties contact information is not visible for either one of the parties. The provision of the check-in reservation notification 36 by the custody service provider 31 establishes that the parties can communicate via the network node 32 using the information in the custody service record 21.

The network node 32, by assessing the custody service record 21, i.e. the check-in reservation notification 36 and the custody service request 33 registered in the custody service record 21, may find out by correlation techniques 38 whether or not the custody service request 33 is accepted by the custody service provider 31.

In the affirmative, the network node 32 forwards a positive or confirming custody service reservation notification 39 to the custody service user 30. If the requested service cannot be accepted by the addressed custody service provider 31, the network node 32 will forward a negative or non-confirming custody service reservation notification 39 to the custody service user 30.

If the custody service user 30, in his or hers custody service request 33, has not specified a preference for a particular custody service provider 31, for example if there are several kindergartens in a shopping centre, the custody service request 33 may be placed in a general custody service record 22, for example. Custody server providers may take such custody service request by browsing the general custody service record 22. As an alternative, the custody service request 33 is registered in a custody service record 21 individual to the requested custody service and may broadcasted by the custody service equipment 25 of the network node 32 to several custody service providers 31, which than may generate a check-in reservation notification 36.

The broadcasting of the custody service request 33 may, for example, also be based on information available to the custody service equipment 25 of the network node 32, concerning availability of one or several custody service providers during a certain requested time period, availability for providing service to a plurality of objects of custody or specific objects of custody, such as babies, for example. To this end, the custody service equipment 25 of the network node 32 is arranged for comparing particularities concerning the custody service request 33 with availability data provided by custody service providers, for example.

Those skilled in the art will appreciate that the custody service request 33, the check-in request 35, and the check-in reservation notification 36 may be comprised of or include the exchange of several messages, for example. That is, within the method of the invention, the custody service request 33, for example, may comprise a first message for setting up an individual custody service record 21, followed by a message comprising data identifying the object of custody, etc. As an alternative, the check-in request 35 may comprise a first message checking availability of the custody service provider 31, followed by a message relating to alternative availabilities, etc. All this, falling within the step of storing data in the electronic database 20 uniquely identifying the object of custody and contact information of parties in a custody relation.

Instead of a general broadcast of a custody service request 33, the correlation 38 by the network node 32 may be arranged to forward a check-in request 35 to several service providers 31 one after the other, till a positive custody service reservation notification 39 can be provided, or not at all.

Once the parents arrive at the respective kindergarten to use the reserved custody service, the object of custody, i.e. the child will be handed over physically for custody.

As illustrated in FIG. 2, to finalize the custody relation, a custody relation acceptance notification 40 is forwarded by the kindergarten staff, i.e. the custody service provider 31, to the network node 32. This custody relation acceptance notification 40 comprises a reference to the particular stored service request 33, i.e. the particular custody service record 21. For referring to a stored custody service request 33, the messages, i.e. request, confirmation, notification and acknowledge, exchanged may comprise a transaction code, a reservation code, a custody relation number, or any other piece of information or code by which the messages exchanged may refer to a particular custody service request, and that can be used by the network node, the custody service provider and the custody service user as a reference to a stored custody service request. For identification purposes of the parents with respect to the kindergarten, a suitable reference is preferably included in the custody service reservation notification 39, i.e. in an SMS stored on the communication equipment 5 of the custody service user 30, for example. This SMS can be showed by the parents to the kindergarten staff as proof of the reservation of the custody service.

The received custody relation acceptance notification 40 is forwarded by the network node 32 to the custody service user 31 as a custody relation acceptance confirmation 41. When the custody service user 30 accepts the start of the custody service, a custody relation acceptance acknowledge message 42 has to be forwarded to the network node 32 in reply to the custody relation acceptance confirmation 41, which eventually leads to the validation of the custody relation 43 by the network node 32. This marks the formal and legal start of the custody relation.

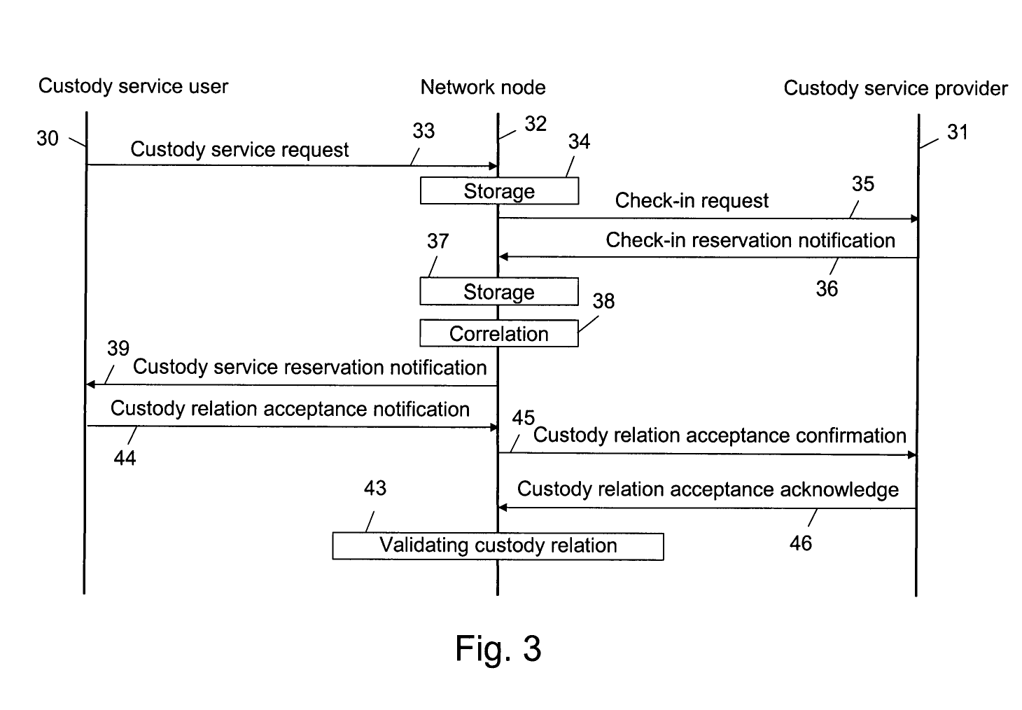

The start of a custody relation may also be established by a custody service user, a schematically illustrated in FIG. 3.

The custody service user forwards to the network node 32, a custody relation acceptance notification 44 comprising a reference to the stored service request 33, i.e. the custody service record 21, as explained above. The custody service provider 31 receives a custody relation acceptance conformation message 45 from the network node 32 and responds, to mark the start of the custody relation, by a custody relation acceptance acknowledge message 46. The custody relation is than validated 43 by the network node 32.

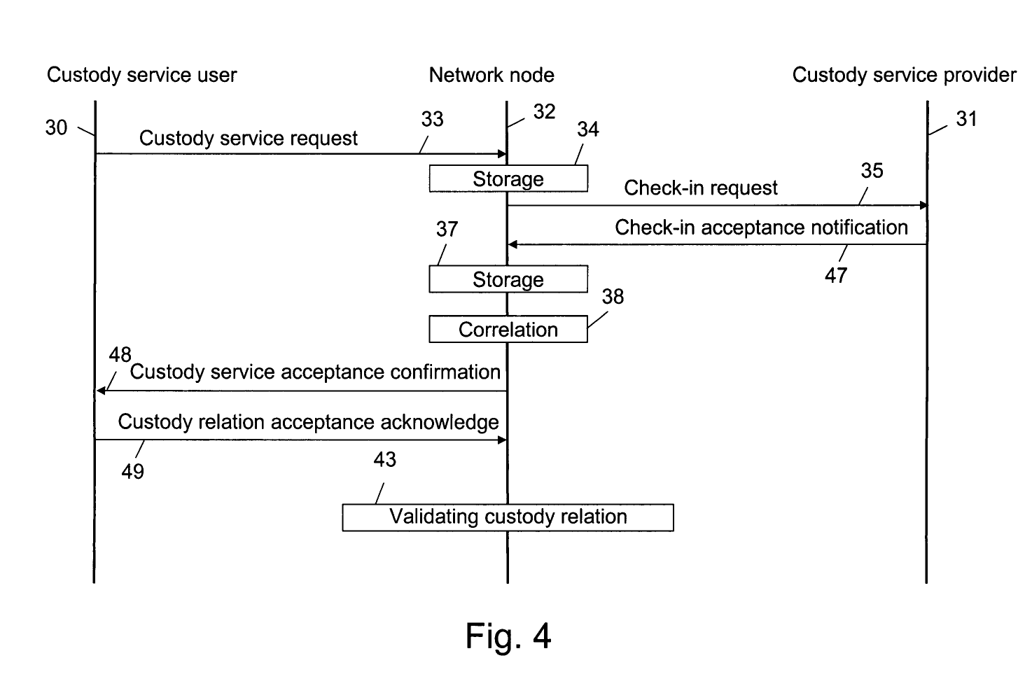

As illustrated in FIG. 4, if a custody relation can start immediately after placing the service request 33, because the parents can hand over the child directly at a particular kindergarten, after receipt of the check-in request 35 by the service provider 31, i.e. the kindergarten, a check-in acceptance notification 47 is returned and stored 37 and correlated 38 with the service request 33 by the network node 32. This as elucidated above.

Assuming that the required information is complete and available, a custody service acceptance confirmation message 48 is send to the custody service user 30. To formally start and approve the custody relation, the custody service user 30 forwards a custody relation acceptance acknowledge 49, and the network node 32 validates 43 the custody relation.

It will be appreciated that a custody relation acceptance acknowledge 49 may be a simple pressing of a “yes” button on a communication terminal, for example.

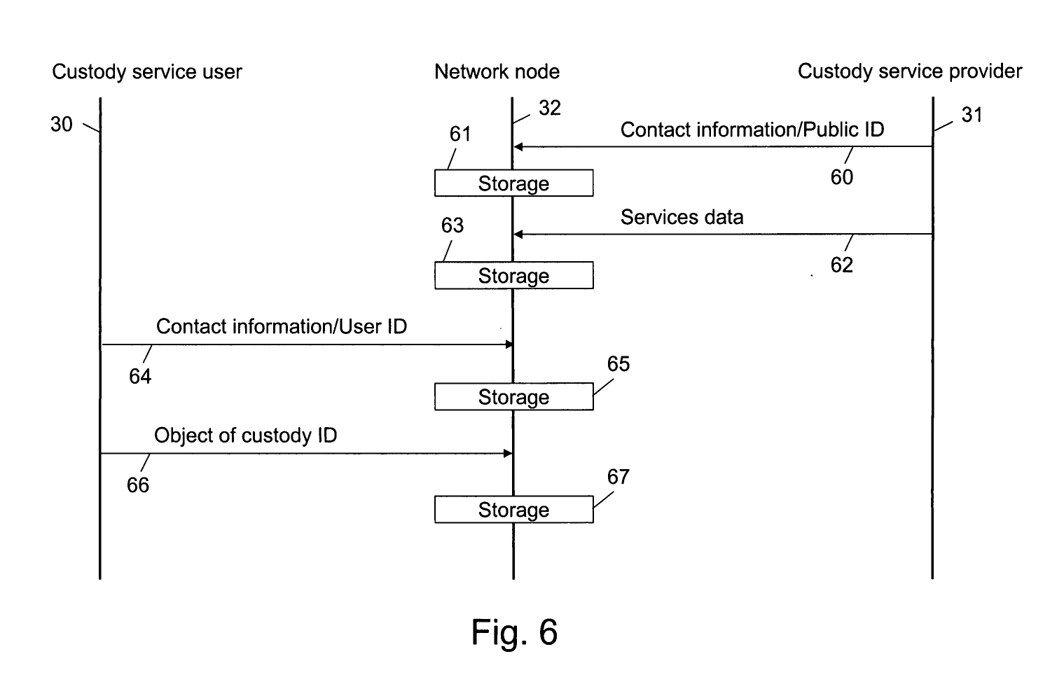

In a further example, as schematically illustrated in FIG. 6, information identifying parties may be semi-permanently pre-stored in the electronic database 20 under control of the custody service equipment 25 of the network node 32. This pre-stored information may be used in establishing very quickly a custody relation between the parties, because a minimum of additional information has to be exchanged in setting up a custody relation. This also enables the use of identification code words, passwords, and the like.

In particular, contact information 60 of a custody service provider may be stored 61 in relation to a public identification, ID, of the service provider, i.e. an individual ID or a group ID, for example. Further, data 62 relating to services available from a custody service provider 31 may be stored 63. This, for example, for directly assessing by the network node 32 whether a requested service is available, for example whether there is space for receiving a child at a particular time of the day, etc.

Contact information 64 of a custody service user 30, against a user identification, ID, may be stored 65. With this feature, a secret telephone number or a secret e-mail address of a custody service user 30 can be kept secret while the user can be identified in the custody relation by its user ID.

In relation to this pre-stored identification information, additional information may be semi-permanently pre-stored in the electronic database 20, such as information 66 identifying the object of custody. One may think of photo's and video's relating to the object of custody, medical and insurance information, and the like. All dependent on the particular custody service requested, for example.

However, additional information may also be registered in a custody service record 21 as provided by the custody service user 30 and/or the custody service provider 31, such as charging information or the like.

In another example, an entry point 23 in the electronic database 20 corresponding to the custody relation between the parties 30, 31 is included in the custody relation acceptance notification 40 or a custody relation acceptance acknowledge 46 received by the custody service equipment 25 of the network node 32. Such an entry point 23 can be a reference to an object under custody, created by the custody service provider 31, for easy reference by the custody service user 30. This may concern a web address that leads to a web cam showing the object under custody, for example.

All this stored information, except for the contact information which may be kept secret to the parties involved, can be remotely available to the custody service user 30 and the custody service provider 31, upon identification, using a suitable telecommunications terminal 5, 6, 7, 9. In the event of a plurality of objects under custody belonging to a same custody relation, selection lists or menu's and query messages may be exchanged between the custody service equipment 25 of the network node 11-19 and the parties involved.

The term semi-permanently stored, among others, implies that the data may be altered and updated by the parties concerned, such as under control of the custody service equipment 25 of the network node 11-19, for example by SMS communication through a telecommunications terminal 5.

The custody relation acceptance notification 40 or the custody relation acceptance acknowledge 46, either retrieved by a custody service user 30 from the electronic database 20 or received by the custody service user 30 from the custody service equipment 25 of the network node 32, may be used as by the custody service user 30 as a proof of entitlement to a respective object of custody. That is, when retrieving the object of custody, the custody service user 30 uses this custody relation acceptance notification 40 or the custody relation acceptance acknowledge 46 as to identify him/herself before the custody service provider 31 concerning a specific custody relation 43 in force.

In such a case, the custody relation acceptance notification 40 or the custody relation acceptance acknowledge 46 is preferably an SMS entry in the telecommunications terminal 5 of the custody service user 30, received from the custody service equipment 25 of the network node.

If no custody relation acceptance notification 40 or custody relation acceptance acknowledge 46 is available to the custody service user 30, stored custody object details may be provided by the custody service user 30 in addition to identification data stored in the custody service record 21, to retrieve the object of custody.

When retrieving the object of custody, a checkout procedure is to be performed, under control of the custody service equipment 25 of a network node 11-19, and to be initiated by either one of the parties involved, i.e. the custody service provider 31 or the custody service user 30.

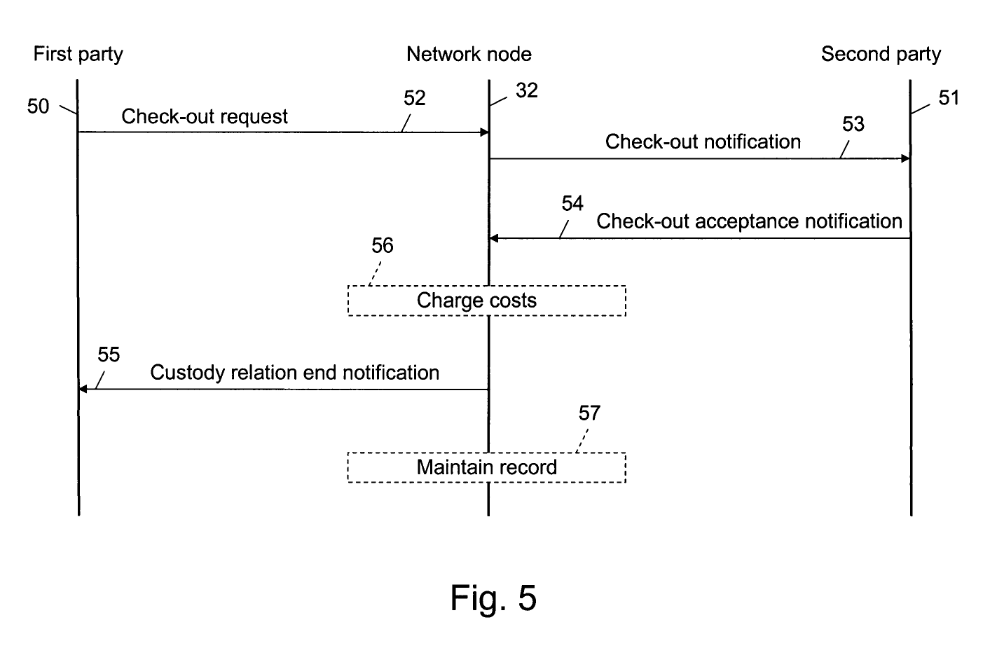

FIG. 5 shows a simplified signal flow diagram of an example of a checkout procedure in accordance with the invention. To emphasize that either one of the parties involved, i.e. the custody service user and the custody service provider, may initiate the checkout, reference numerals 50 and 51 have been used to identify a first party and a second party, respectively.

The custody service equipment 25 of the network node 32 receives a check-out request 52 from a first one 50 of the parties, addressed to the custody service equipment 25 of the network node 32. Like before, in relation to the custody service request 33, the check-out request is directed to the custody service equipment 25 of the network node 32 by selecting or dialing a (special) service subscription number, through a special (text) string in an SMS, via an e-mail address, or any other form of access available to the users or subscribers of the telecommunications system 1, as will be appreciated by a skilled person.

For the remainder, assume that this check-out request 52 is provided by SMS and includes information to retrieve the respective custody relation 43, i.e. the applicable custody service record 21. The information provided may comprise identification data of the party 50, identification data relating to the object of custody, a specific code or the like, that is to say information contained in or linked with the custody service record 21.

After having retrieved the custody service record 21, the custody service equipment 25 of the network node 32 forwards a check-out notification 53 to the second party 51. If the check-out notification 53 is acceptable to the second party 51, the custody service equipment 25 of the network node 32 receives a check-out acceptance notification 54 initiated by the second party 51. In response to receipt of the check-out acceptance notification 54, the custody service equipment 25 of the network node 32, using the contact information available in the custody service record 21, sends a custody relation end notification 55 to the first party 50, thereby terminating the custody relation, i.e. the custody service record 21.

It will be appreciated that at least the forwarding of the check-out acceptance notification 54 and the custody relation end notification 55 is performed in connection with the handover of the object of custody to the custody service user 30. The checkout request 52 may be forwarded to the second party 51 if the object under custody, such as a child, indicates that he or she would like to return to its parent or when a pre-determined custody service time period is about to terminate, for example.

Any of the parties may terminate a custody relation and any of the requests and notifications can be performed remotely, for example by a mobile phone or a data web terminal, as disclosed above, thereby avoiding public announcements as described in the preamble. By concordant statements of both parties, the custody relation linking the parties is terminated.

By sending—by the custody service equipment 25 of the network node 32—the custody relation end notification 55 after receipt of the check-out acceptance notification 54, termination of the custody relation 43 is successfully completed and confirmed. The custody relation end notification 55 may be regarded as a proof that there is no more an obligation between the parties relating to the terminated custody relation or custody service.

In a further example of the invention, the custody service equipment 25 of the network node 11-19 deletes the custody service record 21 relating to a custody relation between parties from the electronic database 20 after having forwarded the custody relation end notification 55 to the first party 50.

All information relating to the custody relation may be deleted from the electronic database 20. However, in a further example a history record 24 comprising data relating to the terminated custody relation is stored or maintained 57 in the electronic database 20, for example comprising data for financial, tax and/or statistical purposes, as indicated by broken lines in FIG. 5.

This enables also to cover multiple custody relations for the same custody service user with one payment, for example, and charging the costs by a network node 11-19 relating to the custody relation to at least one of the parties.

The costs are charged 56, preferably, before the actual termination of the custody relation, as indicated by broken lines in FIG. 5.

It will be appreciated that the principal steps of the check-out procedure disclosed may comprise the exchange of multiple messages, for example.

The invention is, of course, not limited to the use of SMS. Any type of remote communication terminal may be used, and the custody service equipment 25 may be accessible by one or a combination of SMS, MMS, POTS, e-mail, Internet Protocol, IP, ULR, etc. as known to those skilled in the art.

Other custody services besides a look after service of a kindergarten may comprise valet parking, baby-sitter services, a surveillance or bay watch service, and the like. The steps to be performed for invoking such a service are identical to the kindergarten example. Although the invention has been disclosed from initiating the custody service by a custody service user, likewise the custody service may be initiated or created from a custody service provider.

The present invention is not limited to the embodiments disclosed above and illustrated in the drawings.

1-15. (canceled)

16. A method implemented by a network node in a telecommunications system for registering a custody relation in an electronic database, wherein the custody relation describes a relation between a party that provides and a party that uses a temporary custody service for an object of custody, wherein the method comprises:
storing data in the electronic database uniquely identifying the object of custody and contact information for said parties, wherein the parties include a custody service provider providing the temporary custody service and a custody service user associated with the object of custody, and
enabling communication, via said telecommunications system, between the parties using the contact information stored in the database in association with said custody relation.

17. The method according to claim 16, further comprising:
receiving a custody service request from the custody service user, the custody service request requesting a reservation for the provision of said temporary custody service and including data identifying the custody service provider, data identifying the object of custody, and contact information for the custody service user,
storing the custody service request in the electronic database,
forwarding a check-in request to the custody service provider identified in the custody service request,
receiving a check-in reservation notification of the check-in request from the custody service provider, the check-in reservation notification confirming the requested reservation for the provision of said temporary custody service and comprising contact information of the custody service provider,
storing the check-in reservation notification in the electronic database,
correlating the stored check-in reservation notification with the stored custody service request, and
forwarding a custody service reservation notification to the custody service user.

18. The method according to claim 17, further comprising:
receiving a custody relation acceptance notification from the custody service provider, the custody relation acceptance notification requesting that the temporary custody service start and including a reference to the stored custody service request,
forwarding a custody relation acceptance confirmation to the custody service user,
receiving a custody relation acceptance acknowledgement from the custody service user acknowledging the start of the temporary custody service, and
validating the custody relation registered in said electronic database in response to the receipt of the custody relation acceptance acknowledgement.

19. The method according to claim 17, further comprising:
receiving a custody relation acceptance notification from the custody service user, the custody relation acceptance notification requesting that the temporary custody service start and including a reference to the stored custody service request,
forwarding a custody relation acceptance confirmation to the custody service provider,
receiving a custody relation acceptance acknowledgement from the custody service provider acknowledging the start of the temporary custody service, and
validating the custody relation in said electronic database in response to the receipt of the custody relation acceptance acknowledgement.

20. The method according to claim 16, further comprising:
receiving a custody service request from the custody service user, the custody service request requesting the provision of said temporary custody service and including data identifying the custody service provider, data identifying the object of custody, and contact information for the custody service user,
storing the custody service request in the electronic database,
forwarding a check-in request to the custody service provider identified in the custody service request,
receiving a check-in acceptance notification of the check-in request from the custody service provider, the check-in acceptance notification comprising contact information of the custody service provider and indicating that the custody service provider is available to start the temporary custody service,
storing the check-in acceptance notification in the electronic database,
correlating the stored check-in acceptance notification with the stored custody service request, and
forwarding a custody service acceptance confirmation to the custody service user,
receiving a custody relation acceptance acknowledgement from the custody service user acknowledging the start of the temporary custody service, and
validating the custody relation registered in said electronic database in response to the receipt of the custody relation acceptance acknowledge.

21. The method according to claim 16, further comprising providing browsing access by the custody service user and the custody service provider to data stored in the electronic database related to the custody relation.

22. The method according to claim 16, further comprising at least one of:
semi-permanently storing, in the electronic database, contact information for the custody service provider in relation to public identification data of the custody service provider,
semi-permanently storing, in the electronic database, data relating to services of the custody service provider,
semi-permanently storing, in the electronic database, data uniquely identifying the object of custody in relation to identification data of the object of custody, and
semi-permanently storing, in the electronic database, contact information for the custody service user in relation to identification data of the custody service user.

23. The method according to claim 22, further comprising storing and correlating semi-permanently stored data with a received custody service request.

24. The method according to claim 16, further comprising sending information to the parties indicating an entry point in the electronic database for the custody relation.

25. The method according to claim 16, further comprising terminating the custody relation by:
receiving a check-out request from a first one of the parties requesting that said temporary custody service terminate,
sending a check-out notification to a second one of the parties after the check-out request is received,
receiving a check-out acceptance notification from the second party acknowledging the termination of the temporary custody service, and
sending a custody end notification to the first party confirming the termination of the temporary custody service, after receipt of the check-out acceptance notification, and
deleting the custody relation from the electronic database after sending the custody end notification to the first party.

26. The method according to claim 25, further comprising storing a record in the electronic database comprising data related to the terminated custody relation.

27. The method according to claim 16, further comprising charging costs relating to the custody relation to at least one of the parties.

28. The method according to claim 16, further comprising exchanging at least one of data, requests, confirmations, acknowledgements, and notifications associated with registering the custody relation in the electronic database via at least one of e-mail messages, Short Message Service messages, and Multimedia Messaging Service messages.

29. A network node in a telecommunications system for registering a custody relation in an electronic database, wherein the custody relation describes a relation between a party that provides and a party that uses a temporary custody service for an object of custody, wherein the network node comprises custody service equipment configured to:
store data in the electronic database uniquely identifying the object of custody and contact information for said parties, wherein the parties include a custody service provider providing the temporary custody service and a custody service user associated with the object of custody, and
enable communication, via said telecommunications system, between the parties using the contact information stored in the database in association with said custody relation.

30. The network node according to claim 29, wherein the custody service equipment is further configured to:
receive a custody service request from the custody service user, the custody service request requesting a reservation for the provision of said temporary custody service and including data identifying the custody service provider, data identifying the object of custody, and contact information for the custody service user,
store the custody service request in the electronic database,
forward a check-in request to the custody service provider identified in the custody service request,
receive a check-in reservation notification of the check-in request from the custody service provider, the check-in reservation notification confirming the requested reservation for the provision of said temporary custody service and comprising contact information of the custody service provider,
store the check-in reservation notification in the electronic database,
correlate the stored check-in reservation notification with the stored custody service request, and
forward a custody service reservation notification to the custody service user.

31. The network node according to claim 30, wherein the custody service equipment is further configured to:
receive a custody relation acceptance notification from the custody service provider, the custody relation acceptance notification requesting that the temporary custody service start and including a reference to the stored custody service request,
forward a custody relation acceptance confirmation to the custody service user,
receive a custody relation acceptance acknowledgement from the custody service user acknowledging the start of the temporary custody service, and
validate the custody relation registered in said electronic database in response to the receipt of the custody relation acceptance acknowledgement.

32. The network node according to claim 30, wherein the custody service equipment is further configured to:
receive a custody relation acceptance notification from the custody service user, the custody relation acceptance notification requesting that the temporary custody service start and including a reference to the stored custody service request,
forward a custody relation acceptance confirmation to the custody service provider,
receive a custody relation acceptance acknowledgement from the custody service provider acknowledging the start of the temporary custody service, and
validate the custody relation in said electronic database in response to the receipt of the custody relation acceptance acknowledgement.

33. The network node according to claim 29, wherein the custody service equipment is further configured to:
receive a custody service request from the custody service user, the custody service request requesting the provision of said temporary custody service and including data identifying the custody service provider, data identifying the object of custody, and contact information for the custody service user,
store the custody service request in the electronic database,
forward a check-in request to the custody service provider identified in the custody service request,
receive a check-in acceptance notification of the check-in request from the custody service provider, the check-in acceptance notification comprising contact information of the custody service provider and indicating that the custody service provider is available to start the temporary custody service,
store the check-in acceptance notification in the electronic database,
correlate the stored check-in acceptance notification with the stored custody service request, and
forward a custody service acceptance confirmation to the custody service user,
receive a custody relation acceptance acknowledgement from the custody service user acknowledging the start of the temporary custody service, and
validate the custody relation registered in said electronic database in response to the receipt of the custody relation acceptance acknowledge.

34. The network node according to claim 29, wherein the network node comprises either a Private Branch Exchange, PBX, a Service Control Point, SCP, a Mobile Switching Centre, MSC, a Gateway Mobile Switching Center, GMSC, a General Packet Radio Services Support Node, GSN, a Media Gateway, MGW, or a Session Control Function server, SCF.

35. The network node according to claim 29, wherein the electronic database is integrated in or external to the network node.
